(19) United States
(12) Patent Application Publication
(10) Pub. No.: US 2010/0049573 A1
(43) Pub. Date: Feb. 25, 2010

(54) AUTOMATED SECURITY PROVISIONING FOR OUTSOURCED OPERATIONS

(75) Inventors: Daniela Kantorova, Belmont, CA (US); Nigel King, San Mateo, CA (US); Nigel Smith, Redwood City, CA (US); Tapomoy Dey, Santa Clara, CA (US)

Correspondence Address: TOWNSEND AND TOWNSEND AND CREW LLP/ORACLE, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/195,070

(22) Filed: Aug. 20, 2008

(51) Int. Cl. G06Q 10/00; G06F 21/00; H04L 9/32

(52) U.S. Cl. 705/9; 726/1

(57) ABSTRACT

A framework for provisioning security in an enterprise application. In an embodiment, a set of in-house roles and a set of outsourced roles are defined for a business function in the application. When a business unit is selected to perform the business function in-house, data roles specific to that business unit/business function association are created based on the set of in-house roles. When a business unit is selected to perform the business function in an outsourced capacity, data roles specific to that outsourcing relationship are created based on the set of outsourced roles. The data roles may then be associated with one or more users in the selected business unit. Using this framework, the appropriate security roles and privileges for performing a business function in an outsourced and/or in-house context may be explicitly defined within the application system. In addition, the roles and privileges may be provisioned in an automated manner.

### CROSS-REFERENCES TO RELATED APPLICATIONS

The present disclosure is related to the following commonly assigned, co-pending U.S. Patent Application, which is incorporated herein by reference in its entirety for all purposes: application Ser. No. 12/192,583 (Attorney Docket No. 021756-033500US), filed Aug. 15, 2008, entitled “Business Unit Outsourcing Model.”

### BACKGROUND OF THE INVENTION

Embodiments of the present invention relate to enterprise applications, and more particularly related to techniques for provisioning security in an enterprise application to support outsourced operations.

Many organizations, or enterprises, use software applications (hereinafter referred to as “enterprise applications”) to manage various aspects of their business affairs. Generally speaking, these applications facilitate the execution of business processes, track business performance, and the like, thereby improving operational efficiency, adherence to organization policy, and realization of business objectives. Examples of commercially available enterprise applications include, without limitation, JD Edwards Enterpriseone™, PeopleSoft Enterprise™, and the Oracle eBusiness Suite™, all available from Oracle Corporation.

In a typical enterprise application, an enterprise is viewed as a collection of business units. As used herein, a “business unit” is any group within an enterprise that may be considered a discrete entity for one or more purposes, such as for operational/functional distinctions, financial responsibility, managerial reporting, legal reporting, and/or the like. In general, each business unit is configured to perform, via the application, one or more business functions (e.g., payroll function, accounts payable function, sales order function, etc.) with respect to its internal operations.

In some cases, an enterprise may wish to configure its enterprise application(s) to consolidate the execution of business functions for multiple business units within a specific business unit. For example, an enterprise comprising a “US Administration” business unit and a “US Commercial” business unit may wish to consolidate all payment processing in the US Commercial business unit. In this situation, an outsourcing relationship between the two business units may be defined in the application, such that the US Commercial business unit (also known as a “service provider”) is enabled to perform the payment processing function on behalf of the US Administration business unit (also known as a “client”). Techniques for defining outsourcing relationships between various business units, and for configuring enterprise applications to recognize these relationships, are discussed in U.S. patent application Ser. No. 12/192,583, assigned to Oracle Corporation, which is hereby incorporated by reference in its entirety for all purposes.

One issue with configuring enterprise applications to support outsourcing as discussed above relates to application security. Specifically, current enterprise applications do not provide a way to explicitly define the security roles and privileges that should apply to users of a business unit (1) when the business unit is intended to perform a business function in-house (i. e., with respect to its own transactions/data), and (2) when the business unit is intended to perform the business function in an outsourced capacity (i.e., on behalf of another business unit). This can be problematic because, in many cases, certain privileges that should apply in an in-house context should not apply in an outsourced context, and/or vice versa. For example, a payment from petty cash may be acceptable if the invoice is addressed to the business unit making the disbursement, but may represent an untenable risk to a client business unit if the cash payment is made on its behalf by a service provider business unit since this makes traceability and reconciliation of these transactions much more difficult.

Accordingly, there is a need for security provisioning techniques that address these (and other similar) problems.

### BRIEF SUMMARY OF THE INVENTION

Embodiments of the present invention provide a framework for provisioning security in an enterprise application. In an embodiment, a set of in-house roles and a set of outsourced roles are defined for a business function in the application. The set of in-house roles includes security privileges for performing the business function in-house (i.e., with respect to a business unit's own transactions/data), and the set of outsourced roles includes security privileges for performing the business function in an outsourced capacity (i.e., on behalf of another business unit). The security privileges may be different in the two sets. When a business unit is selected to perform the business function in-house, data roles specific to that business unit/business function are created based on the set of in-house roles. When a business unit is selected to perform the business function in an outsourced capacity, data roles specific to that outsourcing relationship are created based on the set of outsourced roles. The data roles may then be associated with users in the selected business unit. Using this framework, the appropriate security roles and privileges for performing a business function in an outsourced and/or in-house context may be explicitly defined within the application system. In addition, the roles and privileges may be provisioned in an automated manner.

According to one embodiment of the present invention, a method for provisioning security in an enterprise application is provided. The method comprises receiving notification of an outsourcing relationship between a first business unit and a second business unit of an enterprise, the outsourcing relationship indicating that the first business unit is intended to perform, via the enterprise application, a business function on behalf of the second business unit. The method further comprises retrieving, in response to receiving the notification, predefined security information for the business function, the predefined security information including a set of in-house roles comprising security privileges for performing the business function in-house, and a set of outsourced roles comprising security privileges for performing the business function in an outsourced capacity. Once the predefined security information has been retrieved, a set of data roles specific to the outsourcing relationship is created based on the set of outsourced roles, the set of data roles including security privileges that enable the first business unit to perform the business function on behalf of the second business unit. In various embodiments, the set of data roles is inherited from the set of outsourced roles, and the security privileges included in the set of data roles are inherited from the security privileges included in the set of outsourced roles. One or more data roles in the set of data roles are then associated with one or more users (or HR positions/job codes) in the first business unit.

In an embodiment, the steps of receiving notification of the outsourcing relationship, retrieving the predefined security information, creating the data roles, and associating the data roles with users are performed by the enterprise application without any human intervention. In an alternative embodiment, the first business unit is notified that the data roles have been created, and the step of associating the data roles with users is performed by a manager (or other user) in the first business unit.

In an embodiment, the method above further comprises receiving notification of an end date for the outsourcing relationship, and applying the end date to the set of data roles, thereby disabling (as of the end date) the security privileges included in the set of data roles. The one or more data roles are then disassociated from the one or more users (or HR positions/job codes) in the first business unit.

In an embodiment, the method above further comprises generating, at runtime of the enterprise application, a user interface screen for executing the business function with respect to one or more transactions, the one or more transactions including at least one transaction originating from the second business unit; and determining whether to allow a user in the one or more users to execute (via the user interface screen) the business function with respect to the at least one transaction based on the data role associated with the user. In various embodiments, the step of determining includes determining whether the data role includes a security privilege granting the user authority to perform the business function with respect to the second business unit.

According to another embodiment of the present invention, another method for provisioning security in an enterprise application is provided. The method comprises receiving notification of an association between a business function and a business unit of an enterprise, the association indicating that the business unit is intended to perform, via the enterprise application, the business function in-house. The method further comprises retrieving, in response to receiving the notification, predefined security information for the business function, the predefined security information including a set of in-house roles comprising security privileges for performing the business function in-house, and a set of outsourced roles comprising security privileges for performing the business function in an outsourced capacity. Once the predefined security information has been retrieved, a set of data roles specific to the business unit/business function association is created based on the set of in-house roles, the set of data roles includes security privileges that enable the business unit to perform the business function in-house. In various embodiments, the set of data roles is inherited from the set of in-house roles, and the security privileges included in the set of data roles are inherited from the security privileges included in the set of in-house roles. One or more data roles in the set of data roles are then associated with one or more users (or HR positions/job codes) in the business unit.

In an embodiment, the steps of receiving notification of the association between the business function and the business unit, retrieving the predefined security information, creating the data roles, and associating the data roles with users are performed by the enterprise application without any human intervention. In an alternative embodiment, the business unit is notified that the data roles have been created, and the step of associating the data roles with users is performed by a manager (or other user) in the business unit.

In an embodiment, the method above further comprises receiving notification of an end date for the association between the business function and the business unit, and applying the end date to the set of data roles, thereby disabling (as of the end date) the security privileges included in the set of data roles. The one or more data roles are then disassociated from the one or more users (or HR positions/job codes) in the business unit.

In an embodiment, the method above further comprises generating, at runtime of the enterprise application, a user interface screen for executing the business function with respect to one or more transactions, the one or more transactions including at least one transaction originating from the business unit; and determining whether to allow a user in the one or more users to execute (via the user interface screen) the business function with respect to the at least one transaction based on the data role associated with the user. In various embodiments, the step of determining includes determining whether the data role includes a security privilege granting the user authority to perform the business function with respect to the business unit.

According to another embodiment of the present invention, a system for executing an enterprise application is provided. The system comprises a storage device for storing data used by the enterprise application, and a processing component in communication with the storage device. In various embodiments, the processing component is configured to receive notification of an outsourcing relationship between a first business unit and a second business unit of an enterprise, the outsourcing relationship indicating that the first business unit is intended to perform, via the enterprise application, a business function on behalf of the second business unit. The processing component is further configured to retrieve, in response to receiving the notification, predefined security information for the business function, the predefined security information including a set of in-house roles comprising security privileges for performing the business function in-house, and a set of outsourced roles comprising security privileges for performing the business function in an outsourced capacity. Once the predefined security information has been retrieved, the processing component is configured to create, based on the set of outsourced roles, a set of data roles specific to the outsourcing relationship, the set of data roles including security privileges that enable the first business unit to perform the business function on behalf of the second business unit. In various embodiments, the set of data roles is inherited from the set of outsourced roles, and the security privileges included in the set of data roles are inherited from the security privileges included in the set of outsourced roles. A user interface is then provided for a user to associate one or more data roles in the set of data roles with one or more users (or HR positions/job codes) in the first business unit.

In an embodiment, the system above further comprises a web server configured to transmit one or more web pages for display in a web browser operated by the user, the one or more web pages comprising the user interface.

According to another embodiment of the present invention, a machine-readable medium for a computer system is provided. The machine-readable medium has stored thereon a computer program which, when executed by a processing component, cause the processing component to receive notification of an outsourcing relationship between a first business unit and a second business unit of an enterprise, the outsourcing relationship indicating that the first business unit is intended to perform, via the enterprise application, a business function on behalf of the second business unit. The computer program further causes the processing component to retrieve, in response to receiving the notification, predefined security information for the business function, the predefined security information including a set of in-house roles comprising security privileges for performing the business function in-house, and a set of outsourced roles comprising security privileges for performing the business function in an outsourced capacity. Once the predefined security information has been retrieved, the computer program causes the processing component to create, based on the set of outsourced roles, a set of data roles specific to the outsourcing relationship, the set of data roles including security privileges that enable the first business unit to perform the business function on behalf of the second business unit. In various embodiments, the set of data roles is inherited from the set of outsourced roles, and the security privileges included in the set of data roles are inherited from the security privileges included in the set of outsourced roles. A user interface is then provided for a user to associate one or more data roles in the set of data roles with one or more users (or HR positions/job codes) in the first business unit.

In an embodiment, the enterprise application comprises the computer program.

A further understanding of the nature and advantages of the embodiments disclosed herein may be realized by reference to the remaining portions of the specification and the attached drawings.

### BRIEF DESCRIPTION OF THE DRAWINGS

Various embodiments in accordance with the present invention will be described with reference to the drawings, in which:

FIG. 1 is a flowchart illustrating the steps performed in provisioning security for an outsourced business function in accordance with an embodiment of the present invention.

FIG. 2 is a flow diagram illustrating the steps of FIG. 1 as performed by various entities of an enterprise in accordance with an embodiment of the present invention.

FIG. 3 is a flowchart illustrating the steps performed in revoking security for an outsourcing relationship that is end-dated in accordance with an embodiment of the present invention.

FIG. 4 is a flow diagram illustrating the steps of FIG. 3 as performed by various entities of an enterprise in accordance with an embodiment of the present invention.

FIG. 5 is a flowchart illustrating the steps performed in provisioning security for a business function performed in-house in accordance with an embodiment of the present invention.

FIG. 6 is a flow diagram illustrating the steps of FIG. 5 as performed by various entities of an enterprise in accordance with an embodiment of the present invention.

FIG. 7 is a flowchart illustrating the steps performed in revoking security for an in-house business function that is end-dated in accordance with an embodiment of the present invention.

FIG. 8 is a flow diagram illustrating the steps of FIG. 7 as performed by various entities of an enterprise in accordance with an embodiment of the present invention.

FIG. 9 is a flowchart illustrating the steps performed in executing an outsourced business function at application runtime in accordance with an embodiment of the present invention.

FIG. 10 is a screen display illustrating a user interface for executing an outsourced business function at application runtime in accordance with an embodiment of the present invention.

FIG. 11 is a simplified block diagram of a system environment that may be used in accordance with an embodiment of the present invention.

FIG. 12 is a simplified block diagram of a computer system that may be used in accordance with an embodiment of the present invention.

In the drawings, the use of like reference numbers in different drawings indicates similar components.

### DETAILED DESCRIPTION OF THE INVENTION

In the following description, for the purposes of explanation, numerous specific details are set forth in order to provide an understanding of the present invention. It will be apparent, however, to one skilled in the art that the present invention may be practiced without some of these specific details. In other instances, well-known structures and devices are shown in block diagram form.

Embodiments of the present invention provide a framework for provisioning security in an enterprise application. Specifically, embodiments of the present invention allow for the explicit definition of in-house roles and outsourced roles for one or more business functions within the application. The in-house roles include security privileges that should apply to a business unit of an enterprise when the business unit performs a business function in-house (i.e., with respect to its own transactions/data). The outsourced rules include security privileges that should apply to a business unit when the business unit performs the business function in an outsourced capacity (i.e., on behalf of another business unit). The in-house and outsourced roles are then used as templates to create data roles specific to a particular in-house or outsourced instance of the business function.

For example, if a US Commercial business unit of an enterprise is selected to perform a payment processing function in-house, data roles specific to the US Commercial business unit would be created from the in-house roles for the payment processing function. Similarly, if the US Commercial business unit is selected to perform the payment processing function in an outsourced capacity on behalf of a US Administration business unit, data roles specific to that outsourcing relationship would be created from the outsourced roles for the payment processing function.

By using predefined in-house roles and outsourced roles to provision security for a business function, the different security privileges that apply in an in-house versus an outsourced context are clearly visible and auditable within the application system. Further, the security can be provisioned with minimal or no human intervention.

As used herein, a “business function” is any function within an enterprise application performed by a business unit of an enterprise. A business function may comprise one or more related tasks. For example, an accounts receivable business function may include invoicing/billing tasks, funds collection/bookkeeping tasks, and/or the like.

A “role” is collection of security privileges that is typically provisioned to a user of an enterprise application. A role may contain privileges that apply to the data/transactions of a specific business unit (e.g., data roles). Alternatively, a role may contain privileges that are not tied to any specific business unit (e.g., the in-house roles and outsourced roles defined for a business function).

A “security privilege” or “privilege” is a right to perform a function or task within an enterprise application. For example, each business function (or task within a business function) may be secured by a privilege. When a role containing one or more privileges is provisioned to a user, the user is granted authority to perform the functions and tasks associated with the one or more privileges.

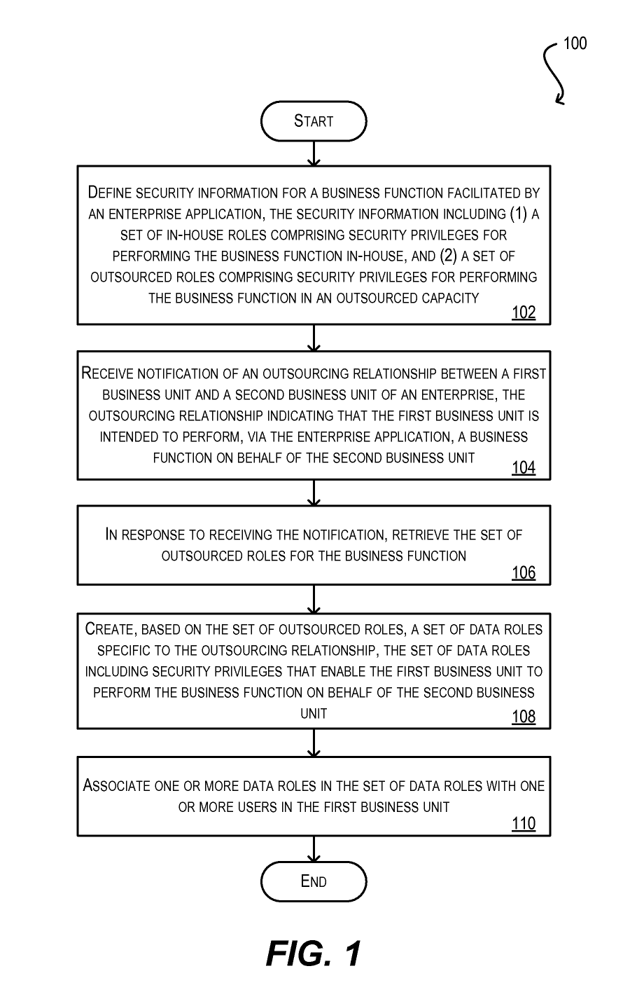

FIG. 1 is a flowchart 100 illustrating the steps performed in provisioning security for an outsourced business function of an enterprise application in accordance with an embodiment of the present invention. In various embodiments, the processing of flowchart 100 may be implemented in software, hardware, or combinations thereof. For example, as software, the processing of flowchart 100 may be implemented in one or more software modules within the enterprise application. Alternatively, the processing of flowchart 100 may be implemented in a security management application that is separate from, but configured to interoperate with, the enterprise application.

At step 102, security information for the business function is defined, the security information including (1) a set of in-house roles comprising security privileges for performing the business function in-house, and (2) a set of outsourced roles comprising security privileges for performing the business function in an outsourced capacity. In a embodiment, these in-house roles and outsourced roles cannot be directed associated with a user of the application. Rather, these roles are used as templates to identify the data roles (and privileges) that should be created when a specific business unit is selected to perform the business function in-house or in an outsourced capacity. Depending on the business function, the roles and/or privileges in the two sets may be different. For example, the in-house roles for a purchasing business function may include the roles of requisitioner, buyer, and category manager. However, the outsourced roles for the same business function may only include the roles of buyer and category manager.

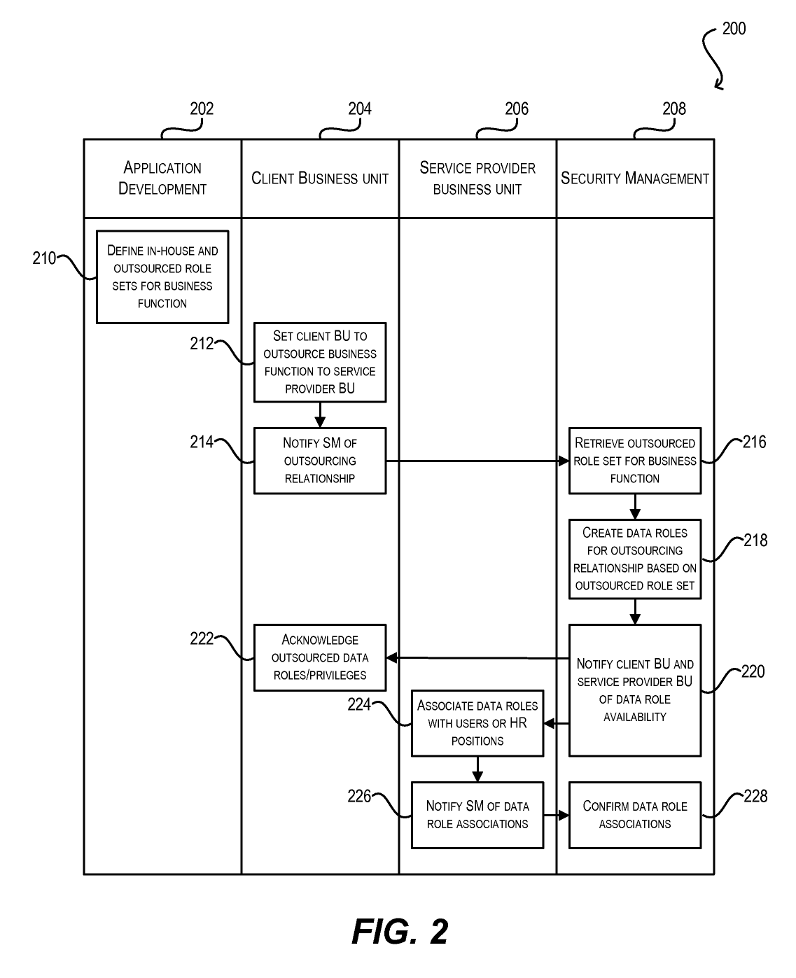

At step 104, notification of an outsourcing relationship between a first business unit and second business unit of an enterprise is received. The outsourcing relationship indicates that the first business unit (i.e., the “service provider business unit”) is intended to perform, via the enterprise application, the business function on behalf of the second business unit (i. e., the “client business unit”). As discussed in greater detail with respect to FIG. 2 below, the outsourcing relationship may be established by an officer, manager, or other user in the client business unit. The outsourcing relationship may also be established by an implementation consultant responsible for configuring the enterprise application.

In response to receiving the notification, the set of outsourced data roles for the business function is retrieved (step 106). A set of data roles specific to the outsourcing relationship between the service provider business unit and the client business unit is then created based on the set of outsourced roles (step 108). In an embodiment, the set of data roles (and its included privileges) are inherited from the set of outsourced roles. However, unlike the set of outsourced roles, the set of data roles specifically enable the service provider business unit to perform the business function with respect to the data/transactions of the client business unit.

For example, assume that the outsourcing relationship indicates that a US Commercial business unit is intended to perform a billing business function of behalf of a US Administration business unit. Further, assume that the outsourced role set for the payables invoicing business function includes a payables management role. In this case, a data role “US Administration Payables Management” will be created based on the payables management role, and the “US Administration Payables Management” data role will inherit all of the privileges included the payables management role. However, the inherited privileges will only allow the US Commercial business unit to perform payables management tasks with respect to the data/transactions of the US Administration business unit. In other words, the created data role is specific to the outsourcing relationship between the US Commercial business unit and the US Administration business unit.

At step 110, the data roles created at step 108 are associated with one or more users in the service provider business unit. In this manner, users in the service provider business unit are granted the appropriate privileges to perform the business function (via the application) on behalf of the client business unit. In one set of embodiments, the data roles may be directly associated with individual users. In alternative embodiments, the data roles may be indirectly associated with users via Human Resources (HR) positions (or jobs) in the service provider business unit. For example, the US Commercial business unit may include an HR position called “Payables Manager” that is performed by one or more individuals. In this situation, the “US Administration Payables Management” data role may be associated with the “Payables Manager” HR position, thereby associating the data role (and its included privileges) with each individual designated as a “Payables Manager.”

It should be appreciated that the steps illustrated in FIG. 1 provide a particular method for provisioning security for an outsourced business function of an enterprise application according to an embodiment of the present invention. Other sequences of steps may also be performed according to alternative embodiments. For example, alternative embodiments of the present invention may perform the steps outlined above in a different order. Moreover, the individual steps illustrated in FIG. 1 may include multiple sub-steps that may be performed in various sequences as appropriate to the individual step. Furthermore, additional steps may be added or removed depending on the particular application. One of ordinary skill in the art would recognize many variations, modifications, and alternatives.

In an embodiment, steps 102-110 of flowchart 100 may be performed in an automated fashion (i.e., with minimal or no human intervention). In another embodiment, steps 104-108 may be automated, and steps 102, 110 may be performed manually. For example, the enterprise application (or other software/hardware module implementing flowchart 100) may be configured to present a first user interface screen that allows an entity/user to define in-house roles and outsourced roles for a business function as per step 102, and a second user interface screen that allows an entity/user to assign data roles to users in the first business unit as per step 110. In yet another embodiment, every step of flowchart 100 may be performed manually. For example, the enterprise application (or other software/hardware module implementing flowchart 100) may be configured to present a series of user interface screens to one or more entities/users, each user interface screen allowing a entity/user to perform or initiate one of steps 102-110.

FIG. 2 is a flow diagram 200 illustrating the steps of FIG. 1 as performed by different entities in an enterprise. In the embodiment shown, four entities—application development 202, client business unit 204, service provider business unit 206, and security management 208—are involved in the process of provisioning security for an outsourced business function. However, alternative embodiments may include more or fewer entities as appropriate for an organization. One of ordinary skill in the art would recognize many variations, modifications, and alternatives.

At step 210, application development 202 defines in-house and outsourced roles for a business function. As used in the figures, “application development” refers to individual(s) responsible for developing the enterprise application and, specifically, responsible for developing the business function. Thus, in this embodiment, the in-house and outsourced roles for a business function are defined prior to releasing the enterprise application to customers. In some embodiments, step 210 may be performed subsequent to application release. For example, step 210 may be triggered at deployment time by a security review. In this case, step 210 may be performed by a security manager rather than an application developer.

At steps 212, 214, client business unit 204 is set to outsource the business function to service provider business unit 206, and security management 208 is notified of the outsourcing relationship. These steps are typically performed during an implementation phase in which the enterprise application is configured for a particular organization. As shown, steps 212, 214 may be carried out by an individual (e.g., business unit manager) in client business unit 204. Steps 212, 214 may also be carried out by an implementation consultant responsible for providing implementation services to the enterprise.

Once the outsourcing relationship is established, security management 208 receives notification of the relationship and retrieves the predefined outsourced roles for the business function (step 216). As used in the figures, “security management” refers to the individual(s) within an organization responsible for implementing information security standards, policies, and procedures to ensure information security. In an embodiment, security management 208 may be represented by a software/hardware-based process rather than one or more individuals. In this embodiment, the steps attributed to security management 208 (steps 216, 218, 220, 226) may be performed in an automated fashion.

At step 218, security management 208 creates data roles specific to the outsourcing relationship based on the predefined outsourced roles for the business function. This step is analogous to step 108 of FIG. 1. In an embodiment, security management 208 may then notify both client business unit 204 and service provider business unit 206 that the data roles have been created and are available.

In response to the notification, client business unit 204 may review and acknowledge the data roles and their included privileges. If the data roles include a role or privilege that should not be granted to service provider business unit 206, the data roles may be rejected or revised at this point. Assuming that the data roles are acceptable, service provider business unit 206 determines associations between the data roles and one or more users or HR positions/job codes in the business unit (step 224). These associations apply the data roles to the users of the service provider business unit, thereby enabling the users to perform the business function on behalf of the client business unit. In an embodiment, service provider business unit 206 may not only determine, but also create the data role associations within the application system. In another embodiment, service provider business unit 206 may communicate the data role associations to security management 208 (step 226), which subsequently confirms the associations and creates them within the application system (step 228).

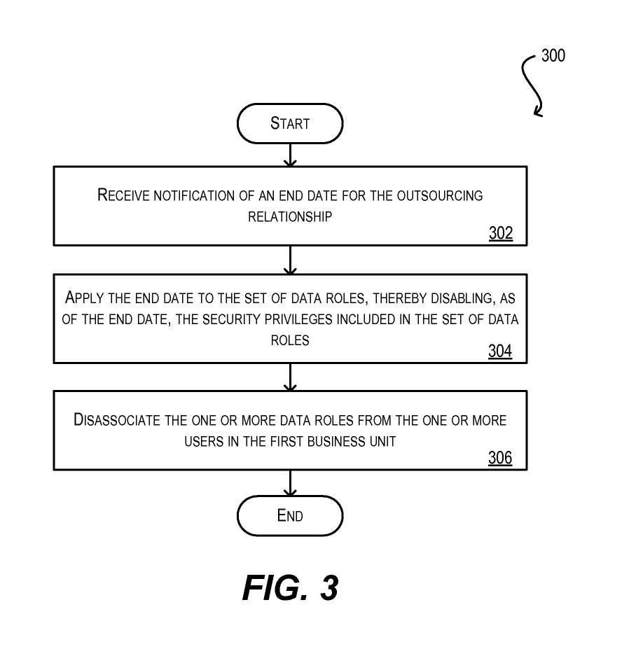

Once a business function has been outsourced and the appropriate security roles and privileges have been provisioned to users in a service provider business unit, the outsourcing relationship may be disabled or end-dated. When this occurs, the provisioned security must be revoked. FIG. 3 is a flowchart 300 illustrating the steps performed in revoking security for an outsourcing relationship that is end-dated in accordance with an embodiment of the present invention. In various embodiments, the processing of flowchart 300 may be implemented in software, hardware, or combinations thereof. For example, as software, the processing of flowchart 300 may be implemented in one or more software modules within the enterprise application. Alternatively, the processing of flowchart 300 may be implemented in a security management application that is separate from, but configured to interoperate with, the enterprise application.

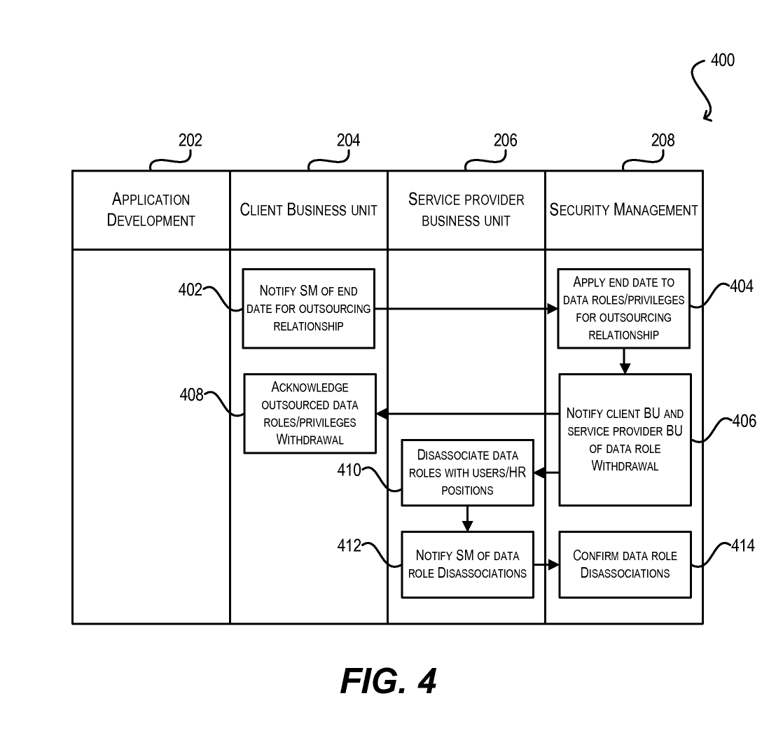

At step 302, a notification of an end date for an outsourcing relationship is received. As described in greater detail with respect to FIG. 4 below, the outsourcing relationship is typically end-dated (or disabled) by the client business unit. In some embodiments, an end date for the outsourcing relationship may be specified at the time the relationship is created, and the notification of step 302 may be automatically generated when the predefined end date has passed.

In response to receiving the notification, the end date is applied to the set of data roles for the outsourcing relationship, thereby disabling the data roles (and their included privileges) as of the end date (step 304). The data roles are then disassociated from the users in the service provider business unit (step 306). In a situation where the data roles were originally associated with HR positions, the data roles are disassociated from the HR positions.

It should be appreciated that the steps illustrated in FIG. 3 provide a particular method for revoking security for an outsourcing relationship that is end-dated according to an embodiment of the present invention. Other sequences of steps may also be performed according to alternative embodiments. For example, alternative embodiments of the present invention may perform the steps outlined above in a different order. Moreover, the individual steps illustrated in FIG. 3 may include multiple sub-steps that may be performed in various sequences as appropriate to the individual step. Furthermore, additional steps may be added or removed depending on the particular application. One of ordinary skill in the art would recognize many variations, modifications, and alternatives.

Like flowchart 100 of FIG. 1, the steps of flowchart 300 may be performed in an automated fashion (i. e., with minimal or no human intervention). In another embodiment, steps 302 and 304 may be automated, and step 306 may be perform manually. For example, the enterprise application (or other software/hardware module implementing flowchart 300) may be configured to present a user interface screen that allows an entity/user to disassociate data roles from users in the first business unit as per step 306. In yet another embodiment, every step of flowchart 300 may be performed manually. For example, the enterprise application (or other software/hardware module implementing flowchart 300) may be configured to present a series of user interface screens to one or more entities/users, each user interface screen allowing an entity/user to perform or initiate one of steps 302-306. [0062] FIG. 4 is a flow diagram 400 illustrating the steps of FIG. 3 as performed by different entities in an organization. As shown, flow diagram 400 references the same entities illustrated in flow diagram 200 of FIG. 2.

At step 402, client business unit 204 notifies security management 208 of an end date for the outsourced relationship. The outsourcing relationship may be end-dated for a variety of reasons. For example, the relationship may be end-dated if the service provider business unit is no longer performing the business function on behalf of other business units. The relationship may be also be end-dated if the relationship was only intended to last for a fixed period of time.

At step 404, security management 208 receives notification of the end date and applies the end date to the data roles (and included privileges) for the outsourcing relationship. As discussed with respect to FIG. 2, security management 208 may correspond to one or more individuals (e.g., security managers) in the organization, or may correspond to a software/hardware-based process. In the latter case, the steps attributed to security management 208 (steps 404, 406, 414) may be performed in an automated fashion.

At step 406, security management 208 notifies both client business unit 204 and service provider business unit 206 that the data roles have been end-dated and thereby withdrawn. In response, client business unit 204 acknowledges the withdrawal (step 408). Further, service provider business unit 206 disassociates the data roles from users or HR positions/job codes in the business unit (step 410). In an embodiment, service provider business unit 206 may commit the data role disassociations within the application system. In another embodiment, service provider business unit 206 may communicate the data role disassociations to security management 208 (step 412), which subsequently confirms the disassociations and commits them within the application system (step 414).

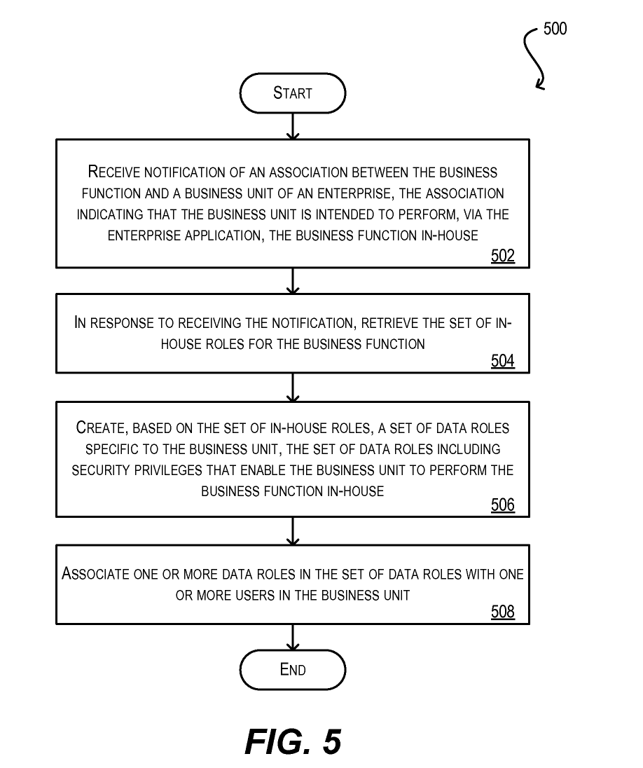

FIG. 5 is a flowchart 500 illustrating the steps performed in provisioning security for a business function performed in-house in accordance with an embodiment of the present invention. In many aspects, flowchart 500 is similar to flowchart 100 of FIG. 1. Flowchart 500 assumes that in-house roles and outsourced roles have already been defined for a business function as per step 102 of FIG. 1.

At step 502, notification of an association between the business function and a business unit of an enterprise is received. The association indicates that the business unit is intended to perform, via the enterprise application, the business function in-house. In other words, the business unit is intend to perform the business function with respect to its own transactions and/or data.

In response to receiving the notification, the set of in-house roles for the business function is retrieved (step 504). A set of data roles specific to the association between the business function and the business unit is then created based on the set of in-house roles (step 506). In an embodiment, the set of data roles (and its included privileges) are inherited from the set of in-house roles. However, unlike the set of in-house roles, the set of data roles specifically enable the business unit to perform the business function with respect to its internal operations.

For example, assume that the association indicates that a US Commercial business unit is intended to perform a payables invoicing business function in-house. Further, assume that the in-house role set for the payables invoicing business function includes a payables management role. In this case, a data role “US Commercial Payables Management” will be created based on the payables management role, and the “US Commercial Payables Management” data role will inherit all of the privileges included the payables management role. However, the inherited privileges will only allow the US Commercial business unit to perform payables management tasks with respect to its own data/transactions. In other words, the created data role is specific to the US Commercial business unit.

At step 508, the data roles created at step 506 are associated with one or more users in the business unit. In this manner, users in the business unit are granted the appropriate privileges to perform the business function (via the application) in-house. In an embodiment, the data roles may be directly associated with individual users. Alternatively, the data roles may be indirectly associated with users via Human Resources (HR) positions (or jobs) in the business unit.

Like flowchart 100 of FIG. 1, the steps of flowchart 500 may be performed in an automated, semi-automated, or manual fashion. In the latter case, the enterprise application (or other software/hardware module implementing flowchart 500) may be configured to present a series of user interface screens to one or more entities/users, each user interface screen allowing an entity/user to perform or initiate one of steps 502-508.

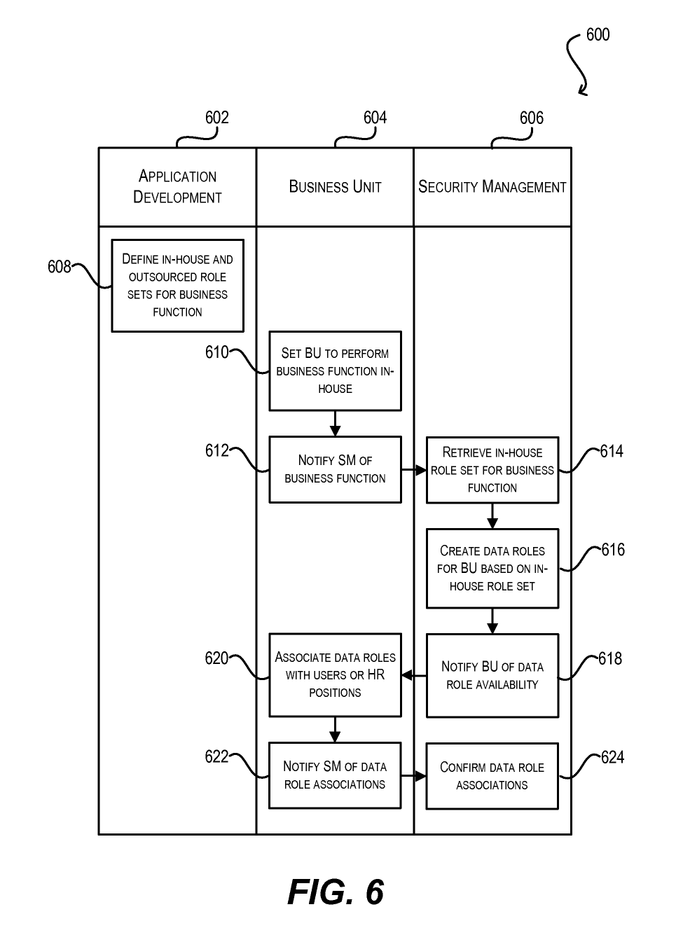

FIG. 6 is a flow diagram 600 illustrating the steps of FIG. 5 as performed by different entities in an enterprise. In the embodiment shown, three entities—application development 602, business unit 604, and security management 606—are involved in the process of provisioning security for an in-house business function. However, alternative embodiments may include more or fewer entities as appropriate for an organization. One of ordinary skill in the art would recognize many variations, modifications, and alternatives.

At step 608, application development 602 defines in-house and outsourced roles for a business function. Generally speaking, this step is identical to step 210 of FIG. 2.

At steps 610, 612, business unit 604 sets itself to perform the business function in-house, and security management 606 is notified of this business function/business unit association. In various embodiments, steps 610, 612 may be carried out by an individual (e.g., business unit manager) in business unit 604 or an implementation consultant responsible for providing implementation services to the organization.

Once the association between the business function and the business unit is established, security management 606 receives notification of the association and retrieves the predefined in-house roles for the business function (step 614). Security management 606 then creates data roles specific to the business function/business unit association based on the predefined in-house roles for the business function (step 616). In an embodiment, security management 606 may then notify business unit 604 that the data roles have been created and are available (step 618).

In response to the notification, business unit 604 determines associations between the data roles and one or more users or HR positions/job codes in the business unit (step 620). These associations apply the data roles to the users of the business unit, thereby enabling the users to perform the business function in-house. In an embodiment, business unit 604 may not only determine, but also create the data role associations within the application system. In another embodiment, business unit 604 may communicate the data role associations to security management 606 (step 622), which subsequently confirms the associations and creates them within the application system (step 624).

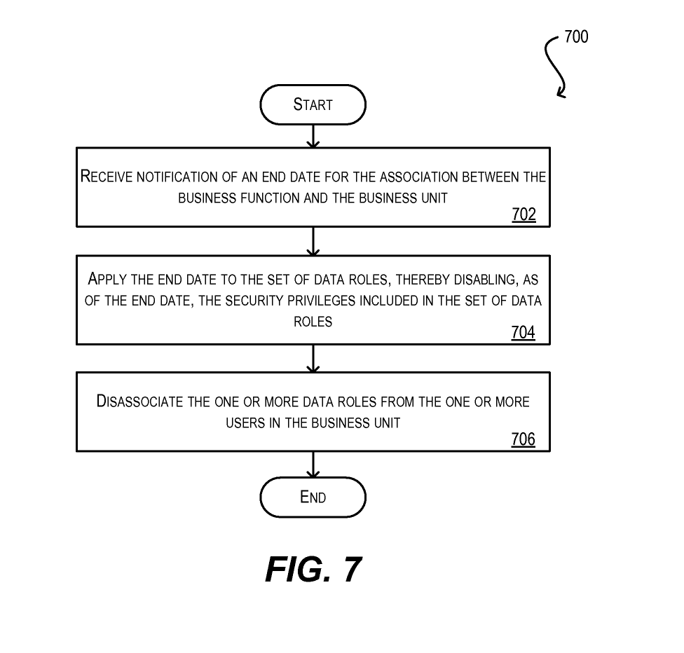

FIG. 7 is a flowchart 700 illustrating the steps performed in revoking security for a business function/business unit association that is end-dated in accordance with an embodiment of the present invention. In many aspects, flowchart 700 is similar to flowchart 300 of FIG. 3.

At step 702, a notification of an end date of an association between a business function and a business unit is received. Typically, the outsourcing relationship is end-dated (or disabled) by the business unit. In some embodiments, an end date may be specified at the time the business function/business unit association is created, and the notification of step 702 may be automatically generated when the predefined end date has passed.

In response to receiving the notification, the end date is applied to the set of data roles for the business unit/business function association, thereby disabling the data roles (and their included privileges) as of the end date (step 704). The data roles are then disassociated from the users in the business unit (step 706). In a situation where the data roles were originally associated with HR positions, the data roles are disassociated from the HR positions.

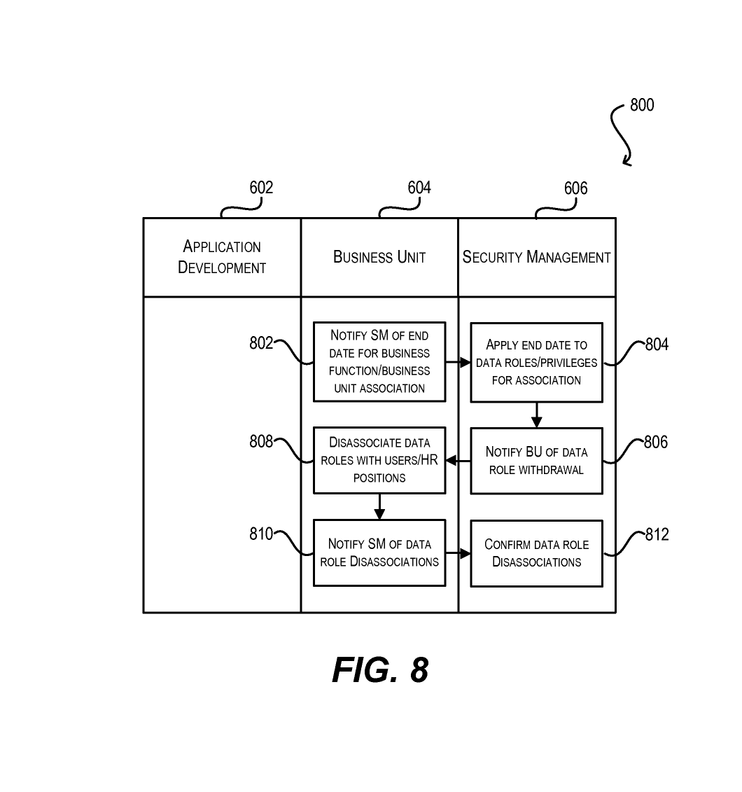

FIG. 8 is a flow diagram 800 illustrating the steps of FIG. 7 as performed by different entities in an enterprise. As shown, flow diagram 800 references the same entities illustrated in flow diagram 600 of FIG. 6.

At step 802, business unit 604 notifies security management 606 of an end date for the business function/business unit association. In response, security management 606 applies the end date to the data roles (and included privileges) for the association (step 804).

At step 806, security management 606 notifies business unit 604 that the data roles have been end-dated and thereby withdrawn. Business unit 604 then disassociates the data roles from users or HR positions/job codes in the business unit (step 808). In an embodiment, business unit 604 may commit the data role disassociations within the application system. In another embodiment, business unit 604 may communicate the data role disassociations to security management 606 (step 810), which subsequently confirms the disassociations and commits them within the application system (step 812).

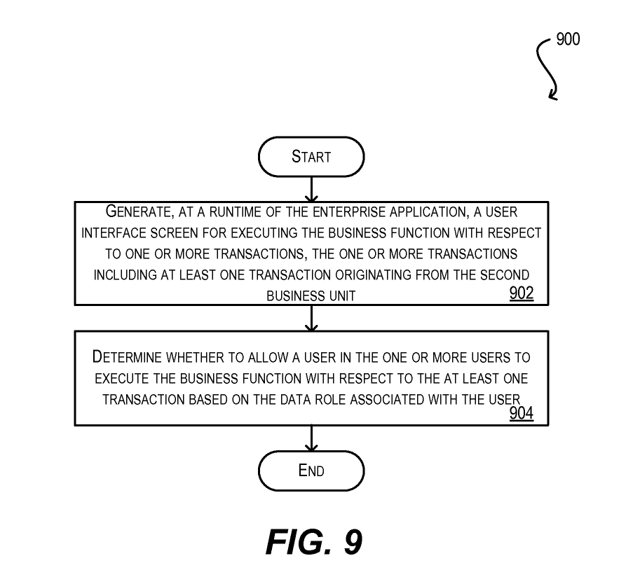

FIG. 9 is a flowchart 900 illustrating the steps performed in executing an outsourced business function within an enterprise application in accordance with an embodiment of the present invention. In particular, flowchart 900 illustrates how the data roles provisioned to a user in a service provider business unit are used at application runtime to deny, or allow, execution of an outsourced business function or task.

At step 902, a user interface screen for executing the business function with respect to one or more transactions is generated by the enterprise application. The one or more transactions include at least one transaction originating from a client business unit.

At step 904, a determination is made whether to allow a user of the enterprise application to execute (via the user interface screen) the business function with respect to the at least one transaction based on the data role associated with the user. In an embodiment, this includes determining whether the data role includes a security privilege granting the user authority to perform the business function with respect to transactions of the client business unit.

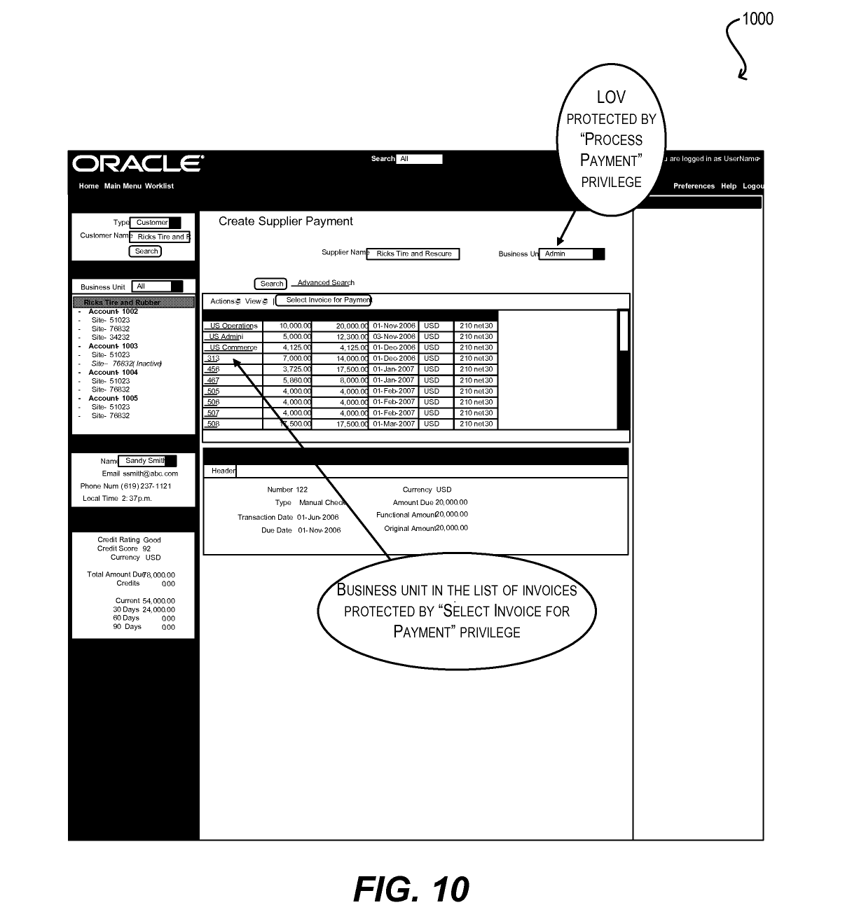

FIG. 10 is a screen display 1000 of an enterprise application illustrating an exemplary user interface for performing an outsourced business function in accordance with an embodiment of the present invention. In particular, screen display 1000 illustrates a user interface for performing a “Create Supplier Payment” business function that includes two tasks—“Process Payment,” and “Select Invoice for Payment.” These tasks are protected by a “Process Payment” privilege and “Select Invoice for Payment” privilege respectively.

If a user in a service provider business unit attempts to access screen display 1000 to perform the “Create Supplier Payment” business function on behalf of a client business unit, the data he sees, and/or the operations he can perform, will be limited by the data roles he (or his HR position) is associated with. For example, in this particular example, the list of business units that appear in the business unit List of Values (LOV) will be limited to the client business units for which the user is granted the “Process Payment” privilege. Similarly, the list of invoices that are returned in the invoices table will be limited to the client business units for the user is granted the “Select Invoice for Payment” privilege (in an embodiment, the service provider business unit itself may be available for this privilege if the user is authorized to perform the function in-house). In this manner, the application system uses the data roles and privileges provisioned to users to regulate the performance of outsourced business functions at application runtime.

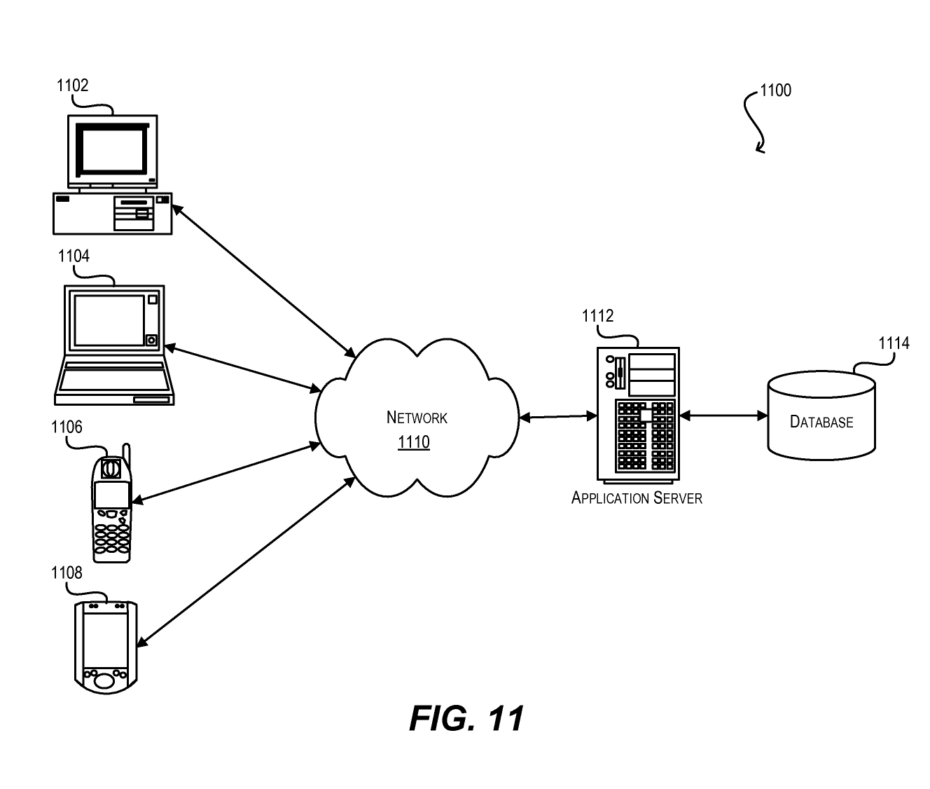

FIG. 11 is a simplified block diagram illustrating components of a system environment 1100 that may be used in accordance with an embodiment of the present invention. As shown, system environment 1100 includes one or more client computing devices 1102, 1104, 1106, 1108, which are configured to operate a client application such as web browser, proprietary client (e.g., Oracle Forms), and/or the like. In various embodiments, client computing devices 1102, 1104, 1106, 1108 are used by entities 202, 204, 206, 208 of FIGS. 2 and 4 and entities 602, 604, 606 of FIGS. 6 and 8 to interact with an enterprise application. For example, client computing devices 1102, 1104, 1106, 1108 may be used to access user interfaces of the enterprise application to provision security for an outsourced or in-house business function as described herein. Additionally, client computing devices 1102, 1104, 1106, 1108 may be used to execute an outsourced or in-house business function within the application, such as via user interface 1000 of FIG. 10.

Client computing devices 1102, 1104, 1106, 1108 may be general purpose personal computers (including, merely by way of example, personal computers and/or laptop computers running various versions of Microsoft Windows and/or Apple Macintosh operating systems), cell phones or PDAs (running software such as Microsoft Windows Mobile and being Internet, e-mail, SMS, Blackberry, or other communication protocol enabled), and/or workstation computers running any of a variety of commercially-available UNIX or UNIX-like operating systems (including without limitation the variety of GNU/Linux operating systems). Alternatively, client computing devices 1102, 1104, 1106, 1108 may be any other electronic device, such as a thin-client computer, Internet-enabled gaming system, and/or personal messaging device, capable of communicating over a network (e.g., network 1110 described below). Although exemplary system environment 1100 is shown with four client computing devices, any number of client computing devices may be supported.

In most embodiments, system environment 1100 includes a network 1110. Network 1110 may be any type of network familiar to those skilled in the art that can support data communications using any of a variety of commercially-available protocols, including without limitation TCP/IP, SNA, IPX, AppleTalk, and the like. Merely by way of example, network 1110 can be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocol); and/or any combination of these and/or other networks.

System environment 1100 also includes one or more server computers 1112 which may be general purpose computers, specialized server computers (including, merely by way of example, PC servers, UNIX servers, mid-range servers, mainframe computers rack-mounted servers, etc.), server farms, server clusters, or any other appropriate arrangement and/or combination. In various embodiments, server 1102 may be adapted to run one or more services or software applications described in the foregoing disclosure. For example, as shown in FIG. 11, server 1112 may act as an enterprise application server configured to execute an enterprise application or one or more other software applications performing the steps of FIGS. 1, 3, 5, 7, 9.

Server 1112 may run an operating system including any of those discussed above, as well as any commercially available server operating system. Server 1112 may also run any of a variety of additional server applications and/or mid-tier applications, including web servers, FTP servers, CGI servers, Java servers, database servers, and the like. Exemplary database servers include without limitation those commercially available from Oracle, Microsoft, Sybase, IBM and the like.

System environment 1100 may also include one or more databases 1114. For instance, databases 1114 may include an application database configured to store transactional data for an enterprise application, a security database configured to store security information pertaining to various business functions of the application, as well as any other type of database or data storage component described in this disclosure. Databases 1114 may reside in a variety of locations. By way of example, one or more of databases 1114 may reside on a storage medium local to (and/or resident in) one or more of the computers 1102, 1104, 1106, 1108, 1112. Alternatively, databases 1114 may be remote from any or all of the computers 1102, 1104, 1106, 1108, 1112, and/or in communication (e.g., via network 1110) with one or more of these. In one set of embodiments, databases 1114 may reside in a storage-area network (SAN) familiar to those skilled in the art. Similarly, any necessary files for performing the functions attributed to the computers 1102, 1104, 1106, 1108, 1112 may be stored locally on the respective computer and/or remotely, as appropriate. In one set of embodiments, databases 1114 may include relational databases, such as Oracle 10 g, that are adapted to store, update, and retrieve data in response to SQL-formatted commands.

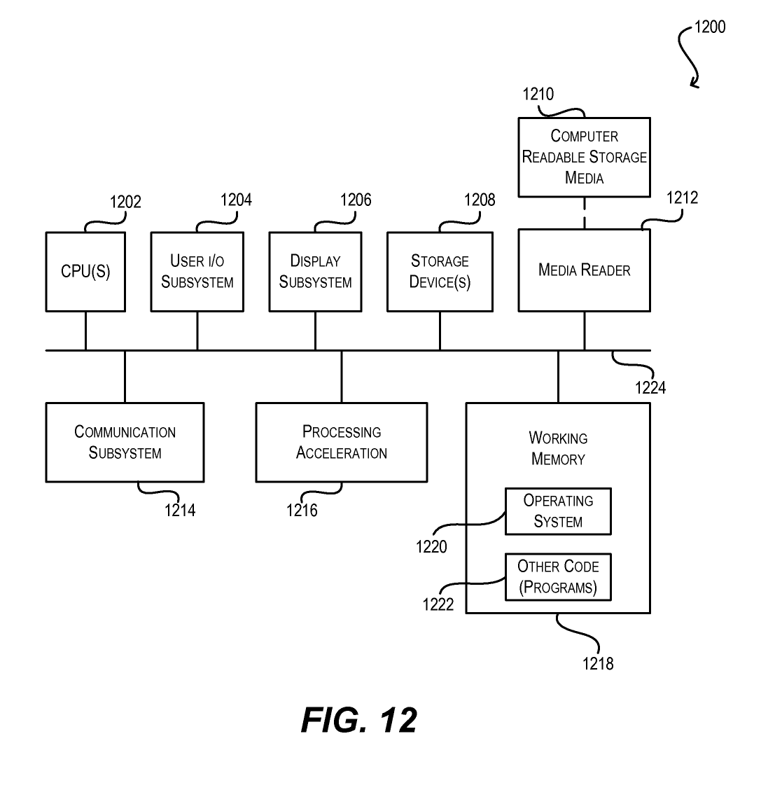

FIG. 12 illustrates a computer system 1200 that may be used in accordance with embodiments of the present invention. In various embodiments, system 1200 may be used to implement any of the computers 1102, 1104, 1106, 1108, 1112 described above. Computer system 1200 is shown comprising hardware elements that may be electrically coupled via a bus 1224. The hardware elements may include one or more central processing units (CPUs) 1202, one or more input devices 1204 (e.g., a mouse, a keyboard, etc.), and one or more output devices 1206 (e.g., a display device, a printer, etc.). Computer system 1200 may also include one or more storage devices 1208. By way of example, the storage device(s) 1208 may include devices such as disk drives, optical storage devices, and solid-state storage devices such as a random access memory (RAM) and/or a read-only memory (ROM), which can be programmable, flash-updateable and/or the like.

Computer system 1200 may additionally include a computer-readable storage media reader 1212, a communications subsystem 1214 (e.g., a modem, a network card (wireless or wired), an infra-red communication device, etc.), and working memory 1218, which may include RAM and ROM devices as described above. In some embodiments, computer system 1200 may also include a processing acceleration unit 1216, which can include a digital signal processor (DSP), a special-purpose processor, and/or the like.

Computer-readable storage media reader 1212 can further be connected to a computer-readable storage medium 1210, together (and, optionally, in combination with storage device(s) 1208) comprehensively representing remote, local, fixed, and/or removable storage devices plus storage media for temporarily and/or more permanently containing computer-readable information. Communications system 1214 may permit data to be exchanged with network 1216 and/or any other computer described above with respect to system environment 1100.

Computer system 1200 may also comprise software elements, shown as being currently located within working memory 1218, including an operating system 1220 and/or other code 1222, such as an application program (which may be a client application, Web browser, mid-tier application, RDBMS, etc.). It should be appreciated that alternative embodiments of computer system 1200 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, o r other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by a computer.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for provisioning security in an enterprise application, the method comprising:
receiving notification of an outsourcing relationship between a first business unit and a second business unit of an enterprise, the outsourcing relationship indicating that the first business unit is intended to perform, via the enterprise application, a business function on behalf of the second business unit;
in response to receiving the notification, retrieving predefined security information for the business function, the predefined security information including
a set of in-house roles comprising security privileges for performing the business function in-house; and
a set of outsourced roles comprising security privileges for performing the business function in an outsourced capacity;
creating, based on the set of outsourced roles, a set of data roles specific to the outsourcing relationship, the set of data roles including security privileges that enable the first business unit to perform the business function on behalf of the second business unit; and
associating one or more data roles in the set of data roles with one or more users in the first business unit.

2. The method of claim 1, wherein the set of data roles is inherited from the set of outsourced roles, and wherein the security privileges included in the set of data roles are inherited from the security privileges included in the set of outsourced roles.

3. The method of claim 1, wherein associating one or more data roles in the set of data roles to one or more users in the first business unit comprises associating the one or more data roles with one or more Human Resources (HR) positions in the first business unit.

4. The method of claim 1 further comprising:
notifying the first and second business units that the set of data roles have been created.

5. The method of claim 1, wherein the steps of receiving, retrieving, creating, and associating are performed by the enterprise application without any human intervention.

6. The method of claim 1, wherein the steps of receiving, retrieving, and creating are performed by the enterprise application without any human intervention, and wherein the step of associating is performed by a user in the first business unit.

7. The method of claim 1 further comprising:
receiving notification of an end date for the outsourcing relationship;
applying the end date to the set of data roles, thereby disabling, as of the end date, the security privileges included in the set of data roles; and
disassociating the one or more data roles from the one or more users.

8. The method of claim 7, wherein disassociating the one or more data roles from the one or more users comprises disassociating the one or more data roles from one or more HR positions in the first business unit.

9. The method of claim 1 further comprising:
generating, at runtime of the enterprise application, a user interface screen for executing the business function with respect to one or more transactions, the one or more transactions including at least one transaction originating from the second business unit; and
determining whether to allow a user in the one or more users to execute the business function with respect to the at least one transaction based on the data role associated with the user.

10. The method of claim 9, wherein the determining comprises:
determining whether the data role includes a security privilege granting the user authority to perform the business function with respect to transactions of the second business unit.

11. A method for provisioning security in an enterprise application, the method comprising:
receiving notification of an association between a business function and a business unit of an enterprise, the association indicating that the business unit is intended to perform, via the enterprise application, the business function in-house;
in response to receiving the notification, retrieving predefined security information for the business function, the predefined security information including
a set of in-house roles comprising security privileges for performing the business function in-house; and
a set of outsourced roles comprising security privileges for performing the business function in an outsourced capacity;
creating, based on the set of in-house roles, a set of data roles specific to the business unit, the set of data roles including security privileges that enable the business unit to perform the business function in-house; and
associating one or more data roles in the set of data roles with one or more users in the business unit.

12. The method of claim 11, wherein the steps of receiving, retrieving, creating, and associating are performed by the enterprise application without any human intervention.

13. The method of claim 11, wherein the steps of receiving, retrieving, and creating are performed by the enterprise application without any human intervention, and wherein the step of associating is performed by a user in the business unit.

14. The method of claim 11 further comprising:
receiving notification of an end date for the association between the business function and the business unit;
applying the end date to the set of data roles, thereby disabling, as of the end date, the security privileges included in the set of data roles; and
disassociating the one or more data roles from the one or more users.

15. The method of claim 11 further comprising:
generating, at runtime of the enterprise application, a user interface screen for executing the business function with respect to one or more transactions, the one or more transactions including at least one transaction originating from the business unit; and
determining whether to allow a user in the one or more users to execute the business function with respect to the at least one transaction based on the data role associated with the user.

16. A system for executing an enterprise application, the system comprising:
a storage device for storing data used by the enterprise application; and
a processing component in communication with the storage device, the processing component being configured to:
receive notification of an outsourcing relationship between a first business unit and a second business unit of an enterprise, the outsourcing relationship indicating that the first business unit is intended to perform, via the enterprise application, a business function on behalf of the second business unit;
in response to receiving the notification, retrieve from the storage device predefined security information for the business function, the predefined security information including
a set of in-house roles comprising security privileges for performing the business function in-house; and
a set of outsourced roles comprising security privileges for performing the business function in an outsourced capacity;
create, based on the set of outsourced roles, a set of data roles specific to the outsourcing relationship, the set of data roles including security privileges that enable the first business unit to perform the business function on behalf of the second business unit; and
provide a user interface for a user to associate one or more data roles in the set of data roles with one or more users in the first business unit.

17. The system of claim 16 further comprising a web server configured to transmit one or more web pages for display in a web browser operated by the user, the one or more web pages comprising the user interface.

18. A machine-readable medium for a computer system, the machine-readable medium having stored thereon a computer program which, when executed by a processing component, causes the processing component to:
receive notification of an outsourcing relationship between a first business unit and a second business unit of an enterprise, the outsourcing relationship indicating that the first business unit is intended to perform, via an enterprise application, a business function on behalf of the second business unit;
in response to receiving the notification, retrieve from the storage device predefined security information for the business function, the predefined security information including
a set of in-house roles comprising security privileges for performing the business function in-house; and
a set of outsourced roles comprising security privileges for performing the business function in an outsourced capacity;
create, based on the set of outsourced roles, a set of data roles specific to the outsourcing relationship, the set of data roles including security privileges that enable the first business unit to perform the business function on behalf of the second business unit; and
provide a user interface for a user to associate one or more data roles in the set of data roles with one or more users in the first business unit.

19. The machine-readable medium of claim 18, wherein the enterprise application comprises the computer program.
